(19) United States
(12) Patent Application Publication
(10) Pub. No.: US 2022/0342050 A1
(43) Pub. Date: Oct. 27, 2022

(54) DISTANCE MEASUREMENT SYSTEM

(71) Applicant: Hitachi-LG Data Storage, Inc., Tokyo (JP)

(72) Inventors: Hisataka SUGIYAMA, Tokyo (JP); Katsuhiko IZUMI, Tokyo (JP); Katsumi ITO, Tokyo (JP)

(21) Appl. No.: 17/714,302

(22) Filed: Apr. 6, 2022

(30) Foreign Application Priority Data
Apr. 23, 2021 (JP) 2021-073696

(51) Int. Cl. G01S 7/4865; G01S 17/10; G01S 7/48

(52) U.S. Cl. CPC G01S 7/4865; G01S 17/10; G01S 7/4808

(57) ABSTRACT

The distance measurement system is a system for measuring a distance to a target by a time of flight of light using a plurality of distance measurement image pickup apparatuses. The plurality of distance measurement image pickup apparatuses may emit pulsed light rays at a plurality of different pulse widths. Further, intervals of pulsed light rays from the plurality of distance measurement image pickup apparatuses are set to be proportional to pulse widths in the respective distance measurement image pickup apparatuses. Further, the respective distance measurement image pickup apparatuses emit pulsed light rays at intervals of the pulsed light rays corresponding to pulse widths and the intervals of the pulsed light rays different from each other.

### CROSS-REFERENCE TO RELATED APPLICATION

The present application claims priority from Japanese application JP2021-073696, filed on Apr. 23, 2021, the contents of which is hereby incorporated by reference into this application.

### BACKGROUND OF THE INVENTION

### 1. Field of the Invention

The present invention relates to a distance measurement system using a plurality of distance measurement image pickup apparatuses that measures a distance to a target by a time of flight of light.

### 2. Description of the Related Art

A time of flight (TOF) method of measuring a distance by a time of flight until irradiation light is reflected by a target and returns has been known as a method of measuring a distance to a target. Specifically, exposure is performed by a plurality of exposure gates in which exposure timings are shifted with respect to a light emission timing of intensity-modulated irradiation light, and a delay time of reflected light with respect to the irradiation light is calculated from the exposure amount accumulated in each exposure gate, thereby obtaining a distance.

In the TOF method, distance measurement accuracy (repeated measurement error) and a distance measurement range (measurable distance range) depend on a pulse width (modulation frequency) of irradiation light, and the shorter the pulse width (the higher the modulation frequency), the higher the distance measurement accuracy and the narrower the distance measurement range. For this reason, a method has been proposed to achieve both high distance measurement accuracy and a wide distance measurement range by measuring distances using two types of irradiation light having a short pulse width and a long pulse width and comparing measurement results.

When a plurality of distance measurement image pickup apparatuses is operated in the same area, there is a problem that an error occurs in a distance measurement value since irradiation light (or reflected light) of an apparatus other than the own apparatus becomes interference light and is exposed by the own apparatus. As a countermeasure, JP 2020-56698 A discloses a technology. In this technology, one frame, which is a unit of measurement operation, includes a first distance measurement period of a width TH of pulsed light and a second distance measurement period of a width TL of pulsed light (however, TH<TL), the first distance measurement period is divided into a plurality of exposure periods obtained by shifting exposure timing with respect to emitted pulsed light, an exposure gate is opened n times (n is plural) at predetermined intervals to perform repeated exposure between one pulsed light ray and a subsequent pulsed light ray in each divided exposure period, a first non-exposure period, in which exposure is not performed from when the exposure gate is finally closed until when a subsequent pulsed light ray is emitted, is provided, the second distance measurement period is divided into a plurality of exposure periods obtained by shifting exposure timing with respect to emitted pulsed light, the exposure gate is opened only once to perform exposure between one pulsed light ray and a subsequent pulsed light ray in each divided exposure period, and a second non-exposure period, in which exposure is not performed from when the exposure gate is closed until when a subsequent pulsed light ray is emitted, is provided.

However, even when the technology of JP 2020-56698 A is used, it is considered that interference cannot be sufficiently suppressed depending on the distance between the apparatuses, which causes a distance measurement error so that distance measurement accuracy becomes insufficient.

### SUMMARY OF THE INVENTION

Therefore, the invention provides a distance measurement system that achieves both high distance measurement accuracy and a wide measurement range and can reduce a distance measurement error by suppressing the effect of interference between apparatuses even when an interval between apparatuses becomes short.

According to of the invention, the following distance measurement system is provided. The distance measurement system is a system for measuring a distance to a target by a time of flight of light using a plurality of distance measurement image pickup apparatuses. Each of the distance measurement image pickup apparatuses includes a light emitting unit, a light receiving unit, a distance computation unit, and a controller. The light emitting unit irradiates the target with pulsed light emitted by a light source. The light receiving unit exposes pulsed light reflected by the target using an image sensor and converts the pulsed light into an electric signal. The distance computation unit computes a distance to the target from an output signal of the light receiving unit. The controller controls a light emission timing for emitting pulsed light from the light emitting unit and an exposure timing for exposing pulsed light by the light receiving unit. The plurality of distance measurement image pickup apparatuses may emit pulsed light rays at a plurality of different pulse widths. Further, intervals of pulsed light rays from the plurality of distance measurement image pickup apparatuses are set to be proportional to pulse widths in the respective distance measurement image pickup apparatuses. Further, the respective distance measurement image pickup apparatuses emit pulsed light rays at intervals of the pulsed light rays corresponding to pulse widths and the intervals of the pulsed light rays different from each other.

The invention provides a distance measurement system that achieves both high distance measurement accuracy and a wide measurement range and can reduce a distance measurement error by suppressing the effect of interference between apparatuses even when an interval between apparatuses becomes short.

### BRIEF DESCRIPTION OF THE DRAWINGS

FIG. 1 is a configuration diagram illustrating a distance measurement image pickup apparatus according to an embodiment of the invention;

FIG. 2 is a diagram for description of a principle of distance measurement by a TOF method;

FIG. 3 is a diagram illustrating a configuration of one frame in distance measurement;

FIG. 4 is a diagram illustrating a flowchart of distance measurement processing in one frame;

FIG. 5A and FIG. 5B are diagrams illustrating light emission/exposure time charts in Example 1;

FIG. 6A and FIG. 6B are diagrams illustrating a distance calculation method in Example 1;

FIG. 7 is a diagram illustrating an example of a measurement result in first/second distance measurement periods;

FIG. 8 is a diagram for description of a method of determining a distance from first/second distance measurement results;

FIG. 9 is a diagram for description of a method of determining a distance from the first/second distance measurement results;

FIG. 10A is a diagram for description of an interference light measure by changing a pulsed light interval;

FIG. 10B is a diagram for description of an interference light measure by changing a pulsed light interval;

FIG. 10C is a diagram for description of an interference light measure by changing a pulsed light interval;

FIG. 10D is a diagram for description of an interference light measure by changing a pulsed light interval;

FIG. 11 is a diagram for description of a cancellation effect of interference light;

FIG. 12 is a diagram illustrating a time chart in a case in which a non-exposure period is provided in a continuous scheme;

FIG. 13 is a diagram illustrating a distance error occurring due to an imbalance in exposure;

FIG. 14A and FIG. 14B are diagrams illustrating light emission/exposure time charts in Example 2;

FIG. 15 is a diagram for description of a method of determining a distance from first/second distance measurement results;

FIG. 16 is a diagram for description of a method of determining a distance from the first/second distance measurement results;

FIG. 17 is a diagram illustrating a case in which a measurement error is likely to occur as a modification of FIG. 5A and FIG. 5B;

FIG. 18 is a diagram for description of occurrence of interference based on different pulse widths;

FIG. 19 is a diagram illustrating an example of a functional block diagram of a distance measurement system; and

FIG. 20 is a diagram illustrating an example of pulse periods set for different pulse widths, respectively.

### DETAILED DESCRIPTION OF THE PREFERRED EMBODIMENTS

Hereinafter, an embodiment of the invention will be described with reference to the drawings. FIG. 1 is a block diagram illustrating a distance measurement image pickup apparatus according to an embodiment of the invention. The distance measurement image pickup apparatus 1 measures a distance to a measurement target 2 such as a person or an object by a TOF method, and outputs a measured distance to each part of the target as two-dimensional (2D) distance data. The distance measurement image pickup apparatus 1 includes a light emitting unit 11, a light receiving unit 12, a distance computation unit 13, and a controller 14. The light emitting unit 11 emits pulsed irradiation light 21 emitted by a light source such as a laser diode (LD) or a light emitting diode (LED). The light receiving unit 12 exposes pulsed reflected light 22 irradiated and reflected back to the target 2 using an image sensor 23 having pixels arranged in a 2D manner such as a charge coupled device (CCD) and a complementary metal oxide semiconductor (CMOS), and converts the light into an electric signal. The distance computation unit 13 computes a distance D from an output signal of the light receiving unit to the target 2. The controller 14 controls the light emitting unit 11, the light receiving unit 12, and the distance computation unit 13, and controls a light emission timing of the irradiation light 21 in the light emitting unit and an exposure timing of the reflected light 22 in the light receiving unit 12. As described above, the distance measurement image pickup apparatus 1 has a configuration similar to that of a digital camera for capturing an image of the target 2 using the image sensor 23, and acquires the distance D to the target 2 as 2D data.

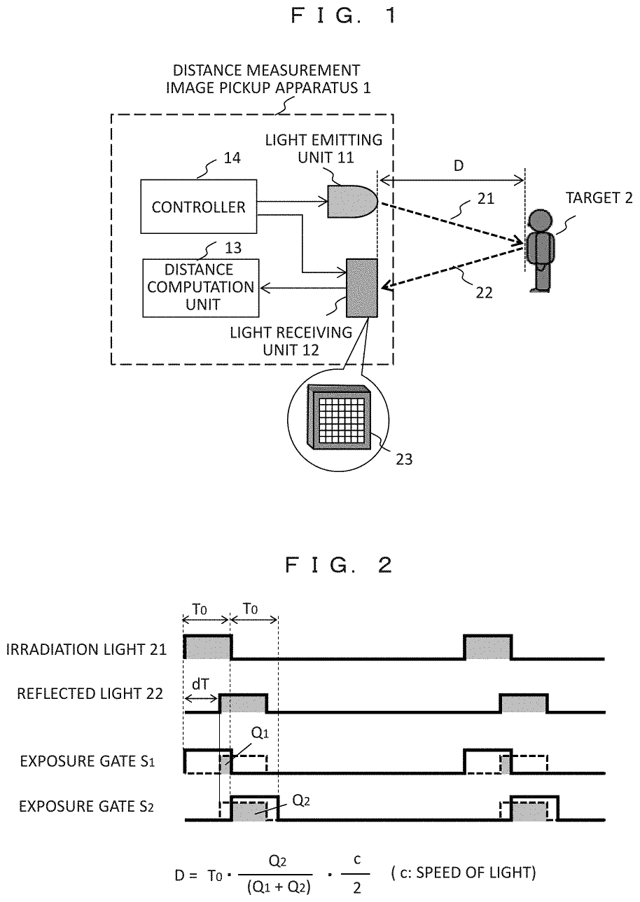

FIG. 2 is a diagram for description of a principle of distance measurement by a TOF method. In the TOF method, the distance D is measured based on a time difference between a signal of the irradiation light 21 and a signal of the reflected light 22, that is, a delay time dT. A relationship between the distance D to the target 2 and the delay time dT is represented by D=dT·c/2, where c is the speed of light.

However, in this example, without directly measuring the delay time dT, a light receiving period is divided into a plurality of exposure gates to indirectly obtain the delay time dT from the exposure amount of each gate period, and the distance D is measured (also referred to as an indirect method).

FIG. 2 illustrates a case in which an exposure operation is performed in, for example, two gates for one-time irradiation light 21 (pulse width T₀). That is, an exposure period of the reflected light 22 is divided into a first exposure gate S₁ and a second exposure gate S₂, and a width of each gate is made equal to the pulse width T₀ of the irradiation light 21. The light receiving unit 12 converts the exposure amounts in the first exposure gate S₁ and the second exposure gate S₂ into charge amounts, and outputs the charge amounts as a first charge amount Q₁ and a second charge amount Q₂.

In this instance, the first and second charge amounts Q₁ and Q₂, the delay time dT, and the distance D to the target 2 are as follows.

dT=T₀·Q₂/(Q₁+Q₂)

D=T₀·Q₂/(Q₁+Q₃)·c/2

That is, the distance D can be calculated by measuring the first charge amount Q₁ and the second charge amount Q₂. The above description corresponds to a principle of distance measurement by the TOF method. In this example, distance measurement is performed by combining two distance measurement schemes of different pulse widths T₀ and exposure gates S₁ and S₂.

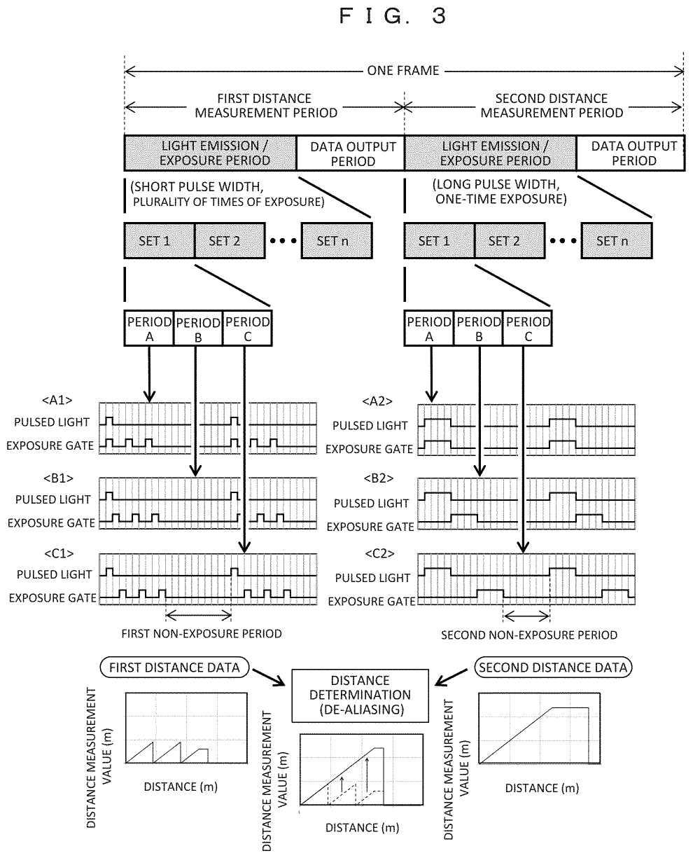

FIG. 3 is a diagram illustrating a configuration of one frame in distance measurement. The distance to the target is measured in units of frames to correspond to an image capturing operation. One frame includes a first distance measurement period and a second distance measurement period having different light emission/exposure timings, and first distance data and second distance data are acquired from each period.

First, the first distance measurement period will be described. In the light emission/exposure period, a light emission/exposure operation of a short pulse width (high modulation frequency) is performed. The light emission/exposure period includes n sets. In one set, periods A, B, and C are included by shifting an exposure timing, and exposure is divided and performed. In each divided period, as indicated by reference symbols A1, B1 and C1, between one light emission pulse and a subsequent light emission pulse, the exposure gate is opened a plurality of times (here, three times) at predetermined intervals to perform exposure, and charges are accumulated. In one set, the light emission/exposure operation is repeated m times, and this operation is repeatedly performed for n sets.

In a data output period, the charge amount for m×n times accumulated in each of the periods A, B, and C is read to calculate the distance, and first distance data in the first distance measurement period is output. As described above, in the first distance measurement period, reflected light for one light emission pulse is exposed a plurality of times at predetermined intervals, and such a light emission/exposure scheme is referred to as an “extended pulse scheme”.

Next, the second distance measurement period will be described. In the light emission/exposure period, light emission/exposure is performed with a long pulse width (low modulation frequency). As in the first distance measurement period, one set has periods A, B, and C having shifted exposure timings, and exposure is divided and performed. However, in each divided period, as indicated by reference symbols A2, B2 and C2, between one light emission pulse and a subsequent light emission pulse, the exposure gate is opened only once to perform exposure and charges are accumulated. The light emission/exposure operation is repeated m times within one set, and this operation is repeatedly performed for n sets.

In a data output period, the charge amount for m×n times accumulated in each of the periods A, B, and C is read to calculate the distance, and second distance data in the second distance measurement period is output. Hereinafter, the light emission/exposure scheme in the second distance measurement period is referred to as a “pulse scheme”.

As described above, widths of the pulsed light and the exposure gate, and the number of exposure repetitions are different between the first distance measurement period and the second distance measurement period. By measuring with a short pulse width (high frequency) in the first distance measurement period, a measurement result having high distance measurement accuracy is obtained. Meanwhile, by measuring with a long pulse width (low frequency) in the second distance measurement period, a measurement result having a wide distance measurement range is obtained. By combining both the measurement results and determining the distance (de-aliasing), it is possible to perform measurement with high distance measurement accuracy and a wide distance measurement range. Any of the first distance measurement period and the second distance measurement period may precede the other one.

Further, the present embodiment is characterized in that in the first distance measurement period and the second distance measurement period, instead of continuously performing one light emission/exposure operation and a subsequent light emission/exposure operation, after closing a last exposure gate until subsequent pulsed light is emitted, the first/second non-exposure periods are inserted, respectively. That is, the “extended pulse scheme” in the first distance measurement period is different from the “continuous scheme” in which the light emission/exposure operation is continuously performed. In this way, by providing the non-exposure period in any of the first distance measurement period and the second distance measurement period, as will be described below, it is possible to reduce a distance measurement error due to interference between apparatuses when a plurality of distance measurement image pickup apparatuses is operated.

The present embodiment describes that the exposure operation for one set is divided into three periods (periods A, B, and C) in which the exposure timing is shifted. However, the number of divided periods is not limited thereto, and an arbitrary number corresponding to a plural number may be adopted.

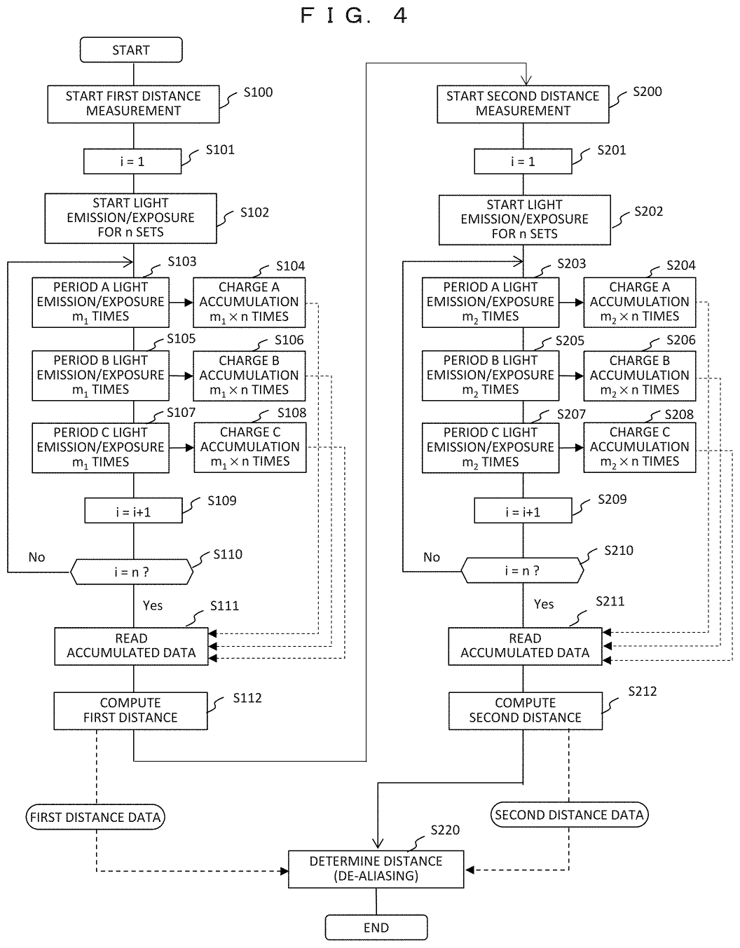

FIG. 4 is a diagram illustrating a flowchart of distance measurement processing in one frame. In one frame period, first distance measurement (S100˜) and second distance measurement (S200˜) are performed, and a distance is determined using distance data of both the first distance measurement and the second distance measurement (S220).

First, when the first distance measurement is started (S100), a counter i is set to 1 (S101), and light emission/exposure for n sets is started (S102). In a light emission/exposure operation, first, in period A light emission/exposure (S103), light emission/exposure indicated by timing A1 of FIG. 3 is performed m₁ times, and charge (charge A) generated by exposure is accumulated (S104). Subsequently, period B light emission/exposure (light emission/exposure indicated by timing B1 of FIG. 3) is performed m₁ times (S105), and charge (charge B) generated by exposure is accumulated (S106). Furthermore, period C light emission/exposure (light emission/exposure indicated by timing C1 of FIG. 3) is performed m₁ times (S107), and charge (charge C) generated by exposure is accumulated (S108). Further, the counter i is incremented by 1 (S109), and it is determined whether the counter i has reached a specified number of times n (S110).

When the specified number of times n has not been reached (No in S110), the process returns to S103 and repeats from the period A light emission/exposure. In this manner, the charge A, the charge B, and the charge C for m₁×n times are accumulated in the light receiving unit 12. When the counter i has reached the specified number of times n (Yes in S110), accumulated data of the charge amount is read from the light receiving unit 12 (S111). The distance computation unit 13 computes a distance (first distance data) to the target 2 using the read amount of the charge A and the charge C (S112).

Subsequently, the second distance measurement is started (S200). Since the second distance measurement has the same procedure as that of the first distance measurement (S100), a repeated description will be omitted. However, in the period A light emission/exposure (S203), light emission/exposure indicated by timing A2 of FIG. 3 is performed m₂ times, and charge (charge A) generated by exposure is accumulated (S204). The period B light emission/exposure (S205) is performed at timing B2 of FIG. 3, and the period C light emission/exposure (S207) is performed at timing C2 of FIG. 3. When the counter i reaches the specified number of times n (Yes in S210), the accumulated data of the charge amount is read from the light receiving unit 12 (S211). The distance computation unit 13 computes the distance to the target 2 (second distance data) using the read amount of the charge A to the charge C (S212).

The distance computation unit 13 determines the distance using the first distance data obtained in S112 and the second distance data obtained in S212 (S220). Details of computation will be described below. In the first distance measurement, distance data repeatedly displayed in units of narrow distance measurement ranges is obtained. On the other hand, in the second distance measurement, distance data of a wide distance measurement range is obtained. Using this data, repetition of the first distance data is solved to determine the distance (de-aliasing).

The number m₁ and m₂ of repetitions of light emission/exposure in one set and the number n of sets in the first distance measurement and the second distance measurement are appropriately set according to the length of one frame period. Next, specific examples of the distance measurement will be described in Example 1 and Example 2.

### Example 1

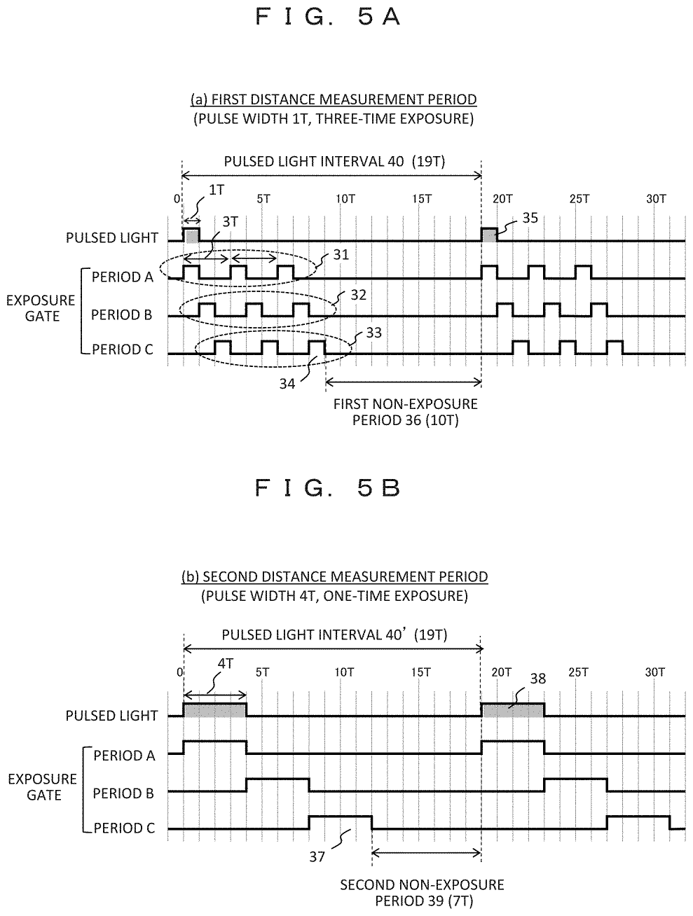

FIG. 5A and FIG. 5B are diagrams illustrating light emission/exposure time charts in Example 1. FIG. 5A illustrates light emission/exposure timing of the first distance measurement period. A short pulse width 1T is used as a light emission pulse, which is exposed by an exposure gate having the same width 1T (high modulation frequency). In the exposure period, exposure is performed in periods A, B, and C, timing of each of which is shifted by 1T. In each period, between one light emission pulse and a subsequent light emission pulse (reference symbol 35), the exposure gate is opened three times in a period 3T to perform repetitive exposure (reference symbols 31, 32, and 33), which corresponds to the “extended pulse scheme” introduced in this example. Then, a first non-exposure period 36 (here, a width of 10T) in which exposure is not performed after a last exposure gate (reference symbol 34) is closed until subsequent pulsed light (reference symbol 35) is emitted is provided. In this way, a pulsed light interval 40 corresponds to a width of 19T.

FIG. 5B illustrates light emission/exposure timing of the second distance measurement period. A long pulse width 4T is used as a light emission pulse, which is exposed by an exposure gate having the same width 4T (low modulation frequency). In the exposure period, exposure is performed in periods A, B, and C, timing of each of which is shifted by 4T. In each period, the exposure gate is opened only once for one light emission pulse to perform exposure, which corresponds to the conventional “pulse scheme”. Then, a second non-exposure period 39 (here, a width of 7T) in which exposure is not performed after a last exposure gate (reference symbol 37) is closed until subsequent pulsed light (reference symbol 38) is emitted is provided. In this way, a pulsed light interval 40′ corresponds to a width of 19T.

Here, even though the pulsed light interval 40 in the first distance measurement period and the pulsed light interval 40′ in the second distance measurement period are made equal to each other, lengths of the non-exposure period 36 and the second non-exposure period 39 may be set so that a ratio thereof has an integer multiple relationship.

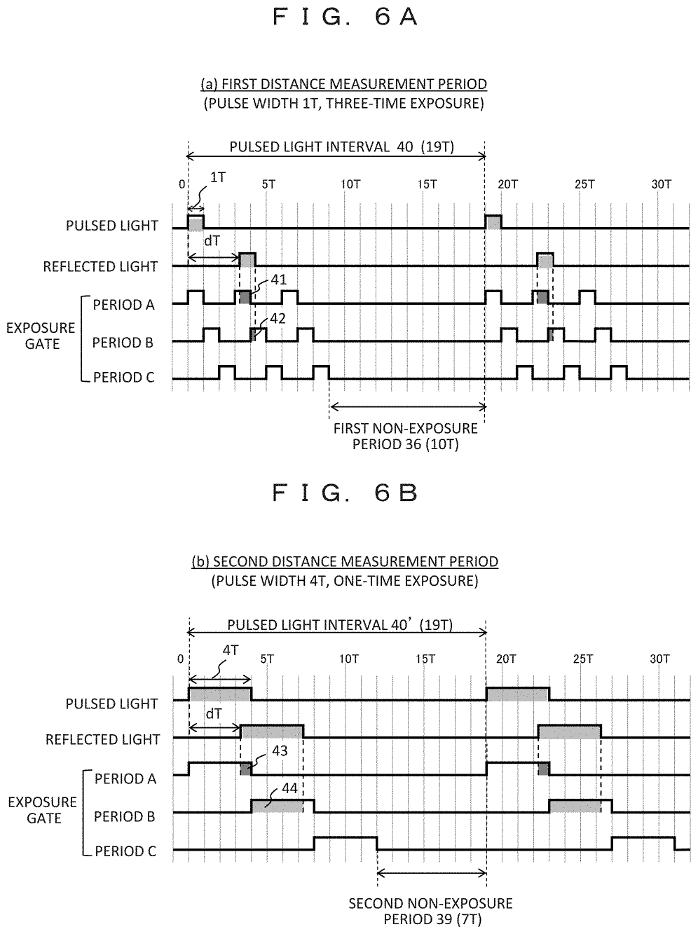

FIG. 6A and FIG. 6B are diagrams illustrating a distance calculation method in Example 1. FIG. 6A illustrates distance calculation in the first distance measurement period.

Reflected light for one light emission pulse is exposed by any two consecutive gates of periods A, B and C. In this example, exposure is performed in the period A and the period B, which is indicated by reference symbols 41 and 42. When the amounts of charges generated by exposure in the periods A, B, and C are set to A, B, and C, respectively, the equation of FIG. 2 is expanded, and a delay time dT of the reflected light with respect to the irradiation light is expressed by the following equation. A calculation formula is divided depending on the magnitude relationship between the charge amounts A, B, and C.

If MIN(A,B,C)=C,

dT={(B−C)/(A+B−2C)}·T+3nT

If MIN(A,B,C)=A,

dT={(C−A)/(B+C−2A)}·T+T+3nT

If MIN(A,B,C)=B,

dT={(A−B)/(C+A−2B)}·T+2T+3nT

Here, MIN is a function for obtaining a minimum value. “n” is a parameter representing an nth period in which exposure is performed in three times of repetitive exposure, and is referred to as the number of repetitions. Here, n=0, 1, and 2 represent the first, second and third times, respectively.

In measurement in the first distance measurement period, it is impossible to specify the number n of repetitions since it is not known at what exposure the signal is obtained.

Therefore, in the first distance measurement period, the first distance data D_{1T} is computed from dT when n=0 as follows.

D_{1T}=c·dT₍ₙ₌₀₎/2

Here, a range of a measurable distance (distance measurement range) will be described. The distance measurement range DR is obtained from a reflected light delay time dT_{R}.

dT_{R}=(pulse width)×(number of times of repetitive exposure×3−1)

D_{R}=c·dT_{R}/2

In the first distance measurement period, since the pulse width=1T and the number of times of repetitive exposure=3,

dT_{R}=1T·(3×3−1)=8T.

On the other hand, in the conventional one-time exposure,

dT_{R}=1T·(1×3−1)=2T.

Thus, the distance measurement range D_{R} is expanded by four times.

FIG. 6B illustrates distance calculation in the second distance measurement period. Reflected light for one light emission pulse is exposed by any two consecutive gates of periods A, B and C, which are indicated by reference symbols 43 and 44. In this case, from the amounts of the charges A, B and C generated by exposure in the periods A, B and C, the delay time dT of the reflected light with respect to the irradiation light is expressed by the following equation. However, in this calculation, the pulse width is replaced with 4T and the number of repetitions is replaced with n=0 in calculation in the first distance measurement period.

If A≥C,dT={(B−C)/(A+B−2C)}·4T

If A<C,dT={(C−A)/(B+C−2A)}·4T+4T

From dT, the second distance data D_{4T} is calculated as follows.

D_{4T}=c·dT/2

When the reflected light delay time is set to dT_{R},

dT_{R}=4T·(1×3−1)=8T.

Thus, the distance measurement range D_{R} in this case matches the distance measurement range D_{R} in the first distance measurement period.

However, in the second distance measurement period, the pulse width of the reflected light is quadrupled and the shot noise is doubled when compared to the first distance measurement period. Therefore, even though the distance measurement range is wide, the measurement accuracy is worse than that in the first distance measurement period.

Thereafter, the number of repetitions n of the first distance measurement period is specified using the second distance data D_{4T} of the second distance measurement period, and an accurate distance D is determined from the first distance data D_{1T}.

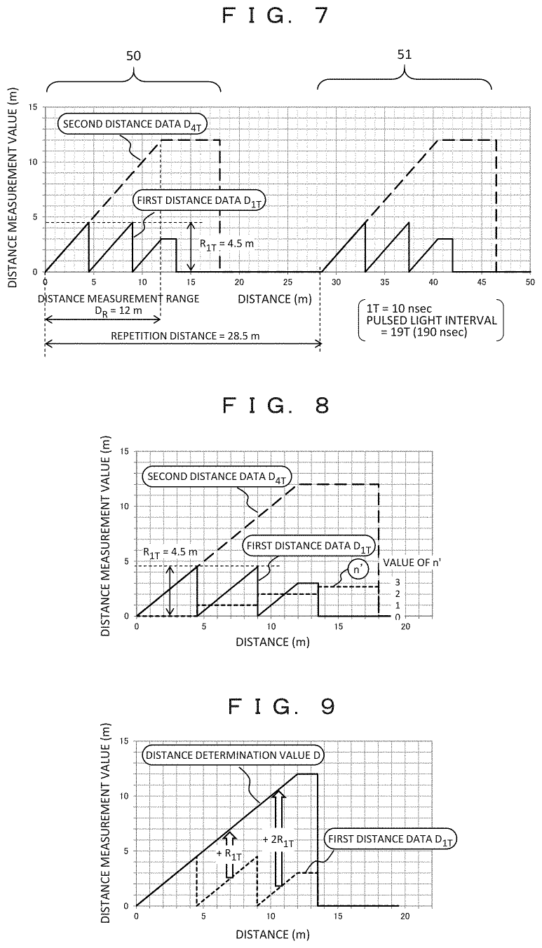

FIG. 7 is a diagram illustrating an example of measurement results of the first and second distance measurement periods. A horizontal axis corresponds to an actual distance to the target, and a vertical axis corresponds to a value of a measured distance. A unit of a time axis in FIGS. 5A and 5B and FIGS. 6A and 6B is set to 1T=10 nsec. When the horizontal axis is represented by a long distance range, a measurement result indicated by reference symbol 50 obtained from a close distance and a measurement result indicated by reference symbol 51 obtained from a long distance are present.

First, in the result indicated by reference symbol 50 obtained from the short distance, the first distance data D_{1T} (indicated by a solid line) in the first distance measurement period (pulse width=1T) is a straight line having a repetition. A distance to a repetition point (repetition distance) R_{1T} is a maximum measurement distance at n=0, and R_{1T}=3cT/2=4.5 m. In addition, a linear portion having a slope is a measurable distance measurement range D_{R}, and 8cT/2=12 m.

The second distance data D_{4T} (indicated by a broken line) in the second distance measurement period (pulse width=4T) is a straight line having no repetition. The distance measurement range D_{R} (gradient part) is 8cT/2=12 m, which is equal to the distance measurement range D_{R} of the first distance data D_{1T}.

Next, the result indicated by reference symbol 51 obtained from a long distance will be described. When the target is at a long distance, the reflected light does not return in an exposure gate period for the pulsed light, and returns in an exposure gate period for subsequent pulsed light. That is, the result indicated by reference symbol 51 is a result measured by pulsed light irradiated one before. In this example, the pulsed light interval is set to 19T (190 nsec), and the measurement result 51 from a position farther than a distance 28.5 m as a starting point is repeatedly obtained in the same pattern as that of the measurement result 50 at the short distance. However, since a flight distance of the pulsed light increases, the intensity of a signal to be exposed attenuates.

However, the measurement result 51 obtained from a long distance is not originally intended and becomes a noise component for the measurement result 50 at a short distance when the measurement result 51 is left. Thus, the measurement result 51 needs to be invalidated. As a countermeasure, the non-exposure period is extended to widen the pulsed light interval, and the reflected light is weak and can be neglected by being moved away to an unexposed distance. However, when the pulsed light interval is excessively widened, the number of times of repetitive exposure within the exposure period decreases and the distance measurement accuracy decreases. Therefore, it is desirable that the pulsed light interval is twice or more the distance measurement range in both the first and second distance measurement periods. When the flight distance of light is doubled, the exposure amount is reduced to ¼, and thus a threshold value can be set for the exposure amount to invalidate the reflected light from a distance of twice or more. Under the condition of Example 1, the pulsed light interval (19T=28.5 m) is about 2.4 times the distance measurement range (8T=12 m).

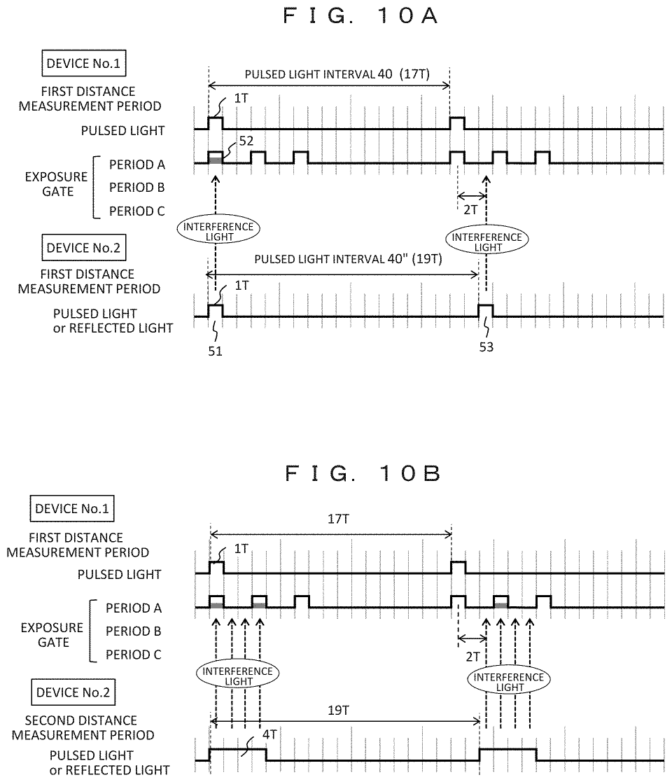

FIG. 8 and FIG. 9 are diagrams for description of a method of determining (de-aliasing) a distance using the first/second distance measurement results.

FIG. 8 illustrates the measurement result indicated by reference symbol 50 of FIG. 7 again. In de-aliasing, using the second distance data D_{4T}, the number n of repetitions in the first distance data D_{1T} (a parameter indicating an nth period in which exposure is performed) is obtained in the following procedure.

First, a ratio n′ of a difference between the first and second distance data to the repetition distance Rn (=3cT/2) of the first distance measurement period is obtained. The ratio n′ is a value corresponding to the number n of repetitions to be obtained.

n′=(D_{4T}−D_{1T})/R_{1T}

n′ is indicated by a dotted line. Since measurement errors are included in the first distance data D_{1T} and the second distance data D_{4T}, n′ is not an original integer value and is involved with a fraction after a decimal point. Therefore, n′ is converted into an integer by a round function (rounding off to the nearest integer).

n=ROUND(n′)

Thus, a real value (integer value) n of the number of repetitions is obtained.

FIG. 9 illustrates a distance output after de-aliasing. Using the real value n of the number of repetitions described above, the accurate distance D is determined by the following equation.

D=D_{1T}+n·R_{1T}=D_{1T}+n·3cT/2

In this calculation, the repetition distance R_{1T} is added n times to the first distance data D_{1T}. Here, since the first distance data D_{1T} has high distance measurement accuracy, and the repetition distance R_{1T} to be added is a constant (3cT/2) determined from a unit time T and the speed of light c, the accurate distance D can be determined. In this way, it is possible to perform measurement achieving both the high distance measurement accuracy and the wide distance measurement range.

Since the distance is beyond the measurement range after 13.5 m, the distance calculation is not performed as invalid data. In this case, a relationship of the charge amount is (A+B−2C)=0, which may be used as a determination condition.

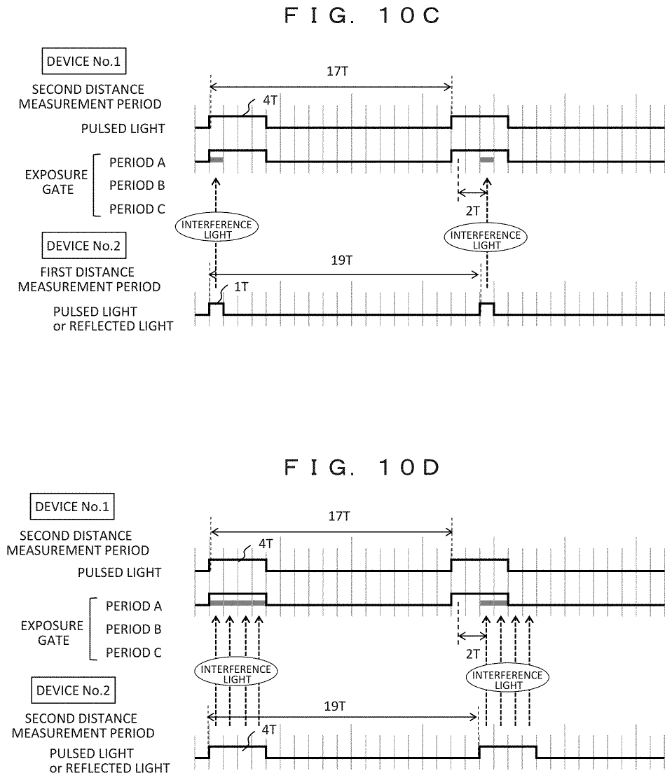

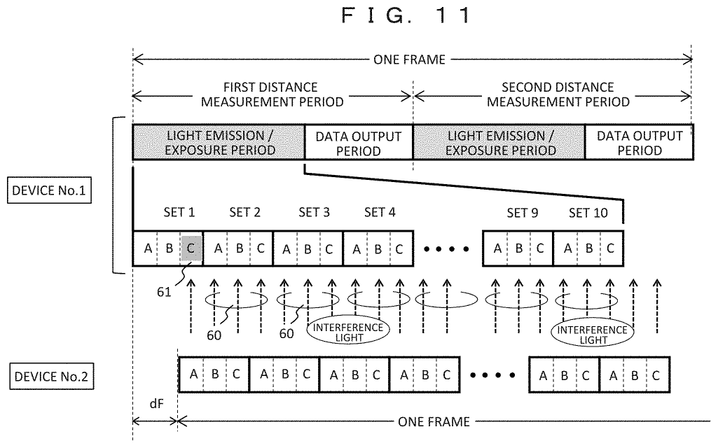

Next, measures against interference light between a plurality of distance measurement image pickup apparatuses will be described. FIG. 10A is a diagram for description of measures against interference light by changing the pulsed light interval. Here, presuming two distance measurement image pickup apparatuses (hereinafter referred to as device No. 1 and device No. 2) simultaneously operating, interference in device No. 1 received from device No. 2 is considered. In each first distance measurement period, a pulsed light interval 40 of device No. 1 is set to 17T, a pulsed light interval 40″ of device No. 2 is set to 19T, and the pulsed light intervals are made different from each other. To change the pulsed light interval in each device, it suffices that the length (see FIGS. 5A and 5B) of the non-exposure period 36 provided in the first distance measurement period is changed for each device. In this instance, since the pulse width (1T) in each device is fixed, the distance measurement accuracy and the distance measurement range do not change.

In this state, an influence of interference light between devices will be described. First, a state in which pulsed light 51 (irradiated light or reflected light) of device No. 2 is used as interference light and exposure is performed at an exposure gate (period A) 52 of device No. 1 is shown. However, subsequent pulsed light 53 (interference light) of device No. 2 is shifted by 2T from the exposure gate (period A) of device No. 1, and thus is not exposed. That is, thereafter, a period in which interference light from device No. 2 is exposed at the exposure gate (period A) of device No. 1 is expanded to a period (17×19T) of the least common multiple of the pulsed light intervals of both devices. However, including the fact that the exposure gate of device No. 1 is repeatedly opened three times in the period A, the amount of interference light to be exposed is reduced to 3/19 when compared to a case in which the pulsed light intervals of both devices are the same (both are 17T). Even though the timing of the exposure gate is different in the other periods (periods B and C), the amount of interference light to be exposed is reduced to 3/19, which is the same as that in the period A.

In the example of FIG. 10A, a description has been given of exposure of interference light from the first distance measurement period of device No. 2 with respect to the first distance measurement period of device No. 1. A combination of the interference light is not limited thereto. A state of interference light of the second distance measurement period of device No. 2 with respect to the first distance measurement period of device No. 1 is illustrated in FIG. 10B, and states of interference light of the first distance measurement period and interference light of the second distance measurement period of device No. 2 with respect to the second distance measurement period of device No. 1 are illustrated in FIG. 10C, and FIG. 10D, respectively. The pulsed light intervals of the second distance measurement periods of device No. 1 and device No. 2 are the same as the first distance measurement periods of the respective devices. The amount of interference light to be exposed is reduced to 6/19 in FIG. 10B and 4/19 in FIG. 10C and FIG. 10D when compared to a case in which the pulsed light intervals of both devices are the same (both are 17T). As described above, when the pulsed light intervals of the first distance measurement period and the second distance measurement period are made equal to each other, the same interference reduction effect can be obtained in any combination. Further, the pulsed light intervals of the first distance measurement period and the second distance measurement period may be set to have an integer multiple relationship. For example, when the pulsed light interval of the second distance measurement period is set to 38T, which is twice the pulsed light interval 19T of the first distance measurement period of device No. 2, the number of times of exposure in the second distance measurement period is reduced to half. However, there is an effect that the amount of interference light received by device No. 1 is reduced to half in FIG. 10B and FIG. 10D.

As described above, a period in which an influence of interference light is received between a plurality of devices expands to the least common multiple of the pulsed light intervals of the respective devices. Therefore, to increase the least common multiple, it is a great idea to set the values of the pulsed light intervals of the respective devices to be relatively prime. In addition, a unit for changing the pulsed light interval is not limited to 1T, and may correspond to an arbitrary numerical value less than 1T such as 0.5T or 0.25T. By setting the value to less than 1T, it is possible to select an interference-avoidable pulsed light interval in a lot of combinations without widening the range of the pulsed light interval.

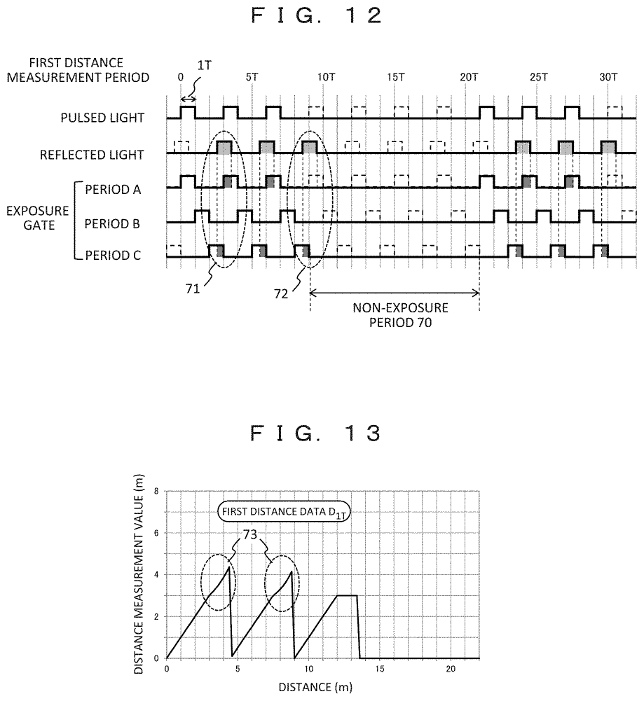

FIG. 11 is a diagram for description of a cancellation effect of interference light. Even when interference light from another device is exposed as illustrated in FIG. 10A, since difference computation of the exposure amount in three periods (periods A, B, and C) is performed in a process of distance computation, a component of interference light is canceled.

In general, a start timing of one frame is difference among a plurality of devices. Thus, a shift by dF occurs in the light emission/exposure periods (including set 1 to set 10) of device No. 1 and device No. 2. In an example of FIG. 11, the light emission/exposure periods of device No. 1 and device No. 2 are shifted from each other by about one set, and overlap each other in a period of set 2 to set 10 of device No. 1. In this overlapping period, device No. 1 exposes substantially the same amount of interference light 60 from device No. 2 at the exposure gates of periods A, B and C. Since these exposed interference light components are canceled in the process of distance computation, almost no distance error occurs.

However, in the first one set, interference light from device No. 2 is exposed only for an exposure gate 61 of the period C, and thus a distance error occurs in this portion. For example, when the pulsed light intervals of device No. 1 and device No. 2 correspond to a combination of FIG. 10A, interference light of 3/19 is exposed at the time of period C exposure as described above. However, since one light emission/exposure period includes the subsequent sets 2 to 10 in which the interference light is canceled, the influence of the interference light amount on the distance error is greatly reduced to 3/19× 1/10= 3/190 in the accumulation within the light emission/exposure period. For this reason, the distance error can be suppressed to a practically acceptable level.

A description will be given of a case in which the shift dF of the start timing of one frame changes and the overlapping period changes. For example, in a case in which interference light is exposed only at the exposure gates of the periods B and C in one set, the interference light is canceled in the periods B and C. Therefore, it suffices that imbalance due to the interference light not being exposed in the period A is considered as the influence, and the imbalance amount is 3/19 as described above. Therefore, in this case, the distance error is reduced to 3/190 in the accumulation within the light emission/exposure period.

In addition, when the start deviation dF exceeds one set period, the number of sets not receiving the interference light from device No. 2 increases, and thus the distance error becomes smaller as a whole.

The cancellation effect of the interference light described here depends on the combination of the pulsed light intervals of device No. 1 and device No. 2, and the pulsed light intervals are set so that the cancellation effect increases. In addition, a combination of pulsed light intervals is determined and applied such that the amount of interference light is reduced in any combination of the first distance measurement period and the second distance measurement period.

As described above, this example is characterized in that the non-exposure period is provided so that the pulsed light intervals of the respective apparatuses are different from each other to avoid interference when operating a plurality of the apparatuses. In this instance, a description has been given of the fact that distance measurement accuracy can be ensured by adopting the “extended pulse scheme” of repeating exposure a plurality of times for a light emission pulse having a short pulse width in the first distance measurement period and providing the non-exposure period thereto. However, the distance measurement accuracy may not be ensured in a method of inserting the non-exposure period in the conventional “continuous scheme”. A reason will be described below.

FIG. 12 is a diagram illustrating a light emission/exposure time chart in a case in which the non-exposure period is provided in the continuous scheme. In the first distance measurement period, pulsed light is continuously irradiated with a short pulse width (high frequency). However, the non-exposure period 70 is inserted every fixed time in an irradiation period. This example shows a case in which a three-time continuous period is set for the pulsed light and the exposure gate, and a four-time non-exposure period 70 is provided thereafter. Then, it is conceivable to change the length of the non-exposure periods 70 to change the interval of the pulsed light to be irradiated to take measures against interference.

When the reflected light from the target is exposed at a timing illustrated in FIG. 12, exposure is performed in the period A and the period C as indicated by reference symbol 71. However, at a timing indicated by reference symbol 72, even though exposure is performed in the period C, exposure is not performed since the exposure gate in the period A is closed, and an imbalance occurs at the amount to be originally exposed in the period A and the period C.

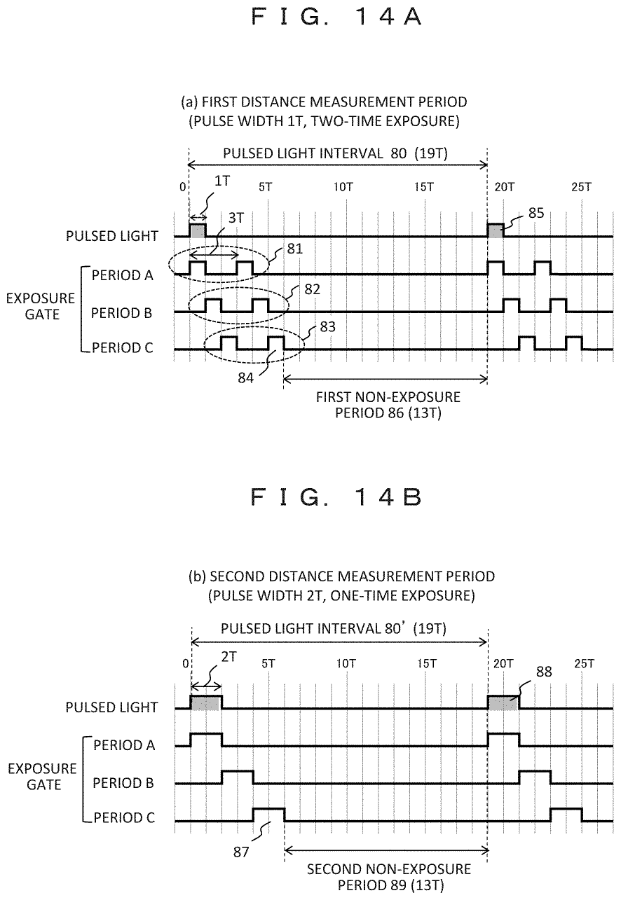

FIG. 13 is a diagram illustrating a distance error occurring due to an imbalance of exposure. First distance data D_{1T} obtained from FIG. 12 is illustrated. A part indicated by reference symbol 73 is not a straight line and includes distortion due to an error. To reduce such a distance error, it suffices to increase the number of consecutive exposure gates. However, when the number of consecutive gates is increased, setting of the non-exposure period 70 is restricted and measures against interference light become insufficient. In other words, it is difficult to reduce distance measurement errors due to interference between a plurality of apparatus while ensuring the high distance measurement accuracy. As described above, the effect as in this example may not be obtained by merely inserting the non-exposure period in the “continuous scheme”.

### Example 2

In Example 2, a description will be given of an example in which the pulse width and the number of times of repetitive exposure are different from those in Example 1.

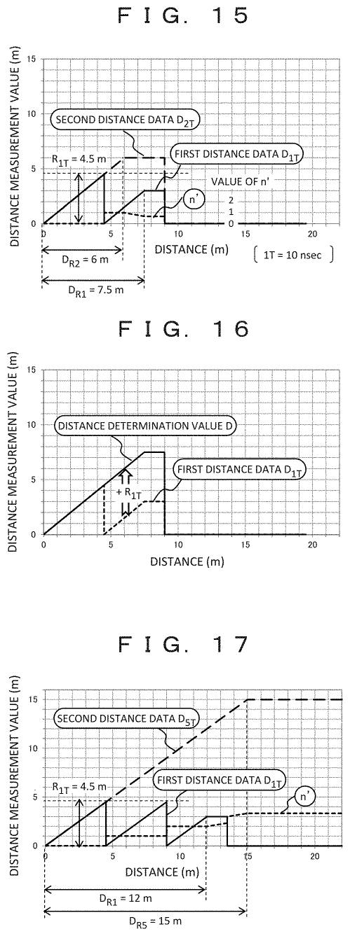

FIG. 14A and FIG. 14B are diagrams illustrating light emission/exposure time charts in Example 2. FIG. 14A illustrates the light emission/exposure timing in the first distance measurement period. A short pulse width 1T is used for the light emission pulse. During the exposure period, exposure is performed in the periods A, B, and C, timing of each of which is shifted by 1T. In each period, the exposure gate is opened twice in a period 3T for one light emission pulse and repetitive exposure is performed (reference symbols 81, 82, and 83). That is, in this case, the “extended pulse scheme” is used. Then, from when a last exposure gate (reference symbol 84) is closed until subsequent pulsed light (reference symbol 85) is emitted, a first non-exposure period (here, a width of 13T) in which exposure is not performed is provided. In this way, a pulsed light interval 80 has a width of 19T.

FIG. 14B illustrates the light emission/exposure timing in the second distance measurement period. A long pulse width 2T is used for the light emission pulse. During the exposure period, exposure is performed in the periods A, B, and C, timing of each of which is shifted by 2T. In each period, the exposure gate is opened once for one light emission pulse and exposure is performed, which corresponds to the conventional “pulse scheme”. Then, from when a last exposure gate (reference symbol 87) is closed until subsequent pulsed light (reference symbol 88) is emitted, a second non-exposure period (here, a width of 13T) in which exposure is not performed is provided. In this way, a pulsed light interval 80′ has a width of 19T, which is equal to the pulsed light interval 80 in the first distance measurement period.

Next, the distance calculation method of Example 2 will be described (a figure corresponding to FIGS. 6A and 6B is omitted). As in Example 1, the charge amounts of the reflected light exposed in the periods A, B, and C are set to A, B, and C, respectively. First, distance calculation in the first distance measurement period of FIG. 14A is shown. The delay time dT of the reflected light with respect to the irradiation light is expressed by the following equation.

If MIN(A,B,C)=C,

dT={(B−C)/(A+B−2C)}·T+3nT

If MIN(A,B,C)=A,

dT={(C−A)/(B+C−2A)}·T+T+3nT

If MIN(A,B,C)=B,

dT={(A−B)/(C+A−2B)}·T+2T+3nT

Here, n is the number of repetitions representing an nth period in which exposure is performed in two times of repetitive exposure, and n=0, 1 indicate the first time and the second time, respectively.

In measurement in the first distance measurement period, it is impossible to specify the number n of repetitions. Therefore, in the first distance measurement period, the first distance data D_{1T} is computed from dT when n=0 as follows.

D_{1T}=c·dT₍ₙ₌₀₎/2

Next, distance calculation in the second distance measurement period of FIG. 14B is shown. The delay time dT of the reflected light respect to the irradiation light is expressed by the following equation.

If A≥C,dT={(B−C)/(A+B−2C)}·2T

If A<C,dT={(C−A)/(B+C−2A)}·2T+2T

From dT, the second distance data D_{2T} is calculated.

D_{2T}=c·dT/2

Thereafter, the number n of repetitions of the first distance measurement period is specified using the measurement result D_{2T} of the second distance measurement period, and the accurate distance D is determined from the first distance data D_{1T}.

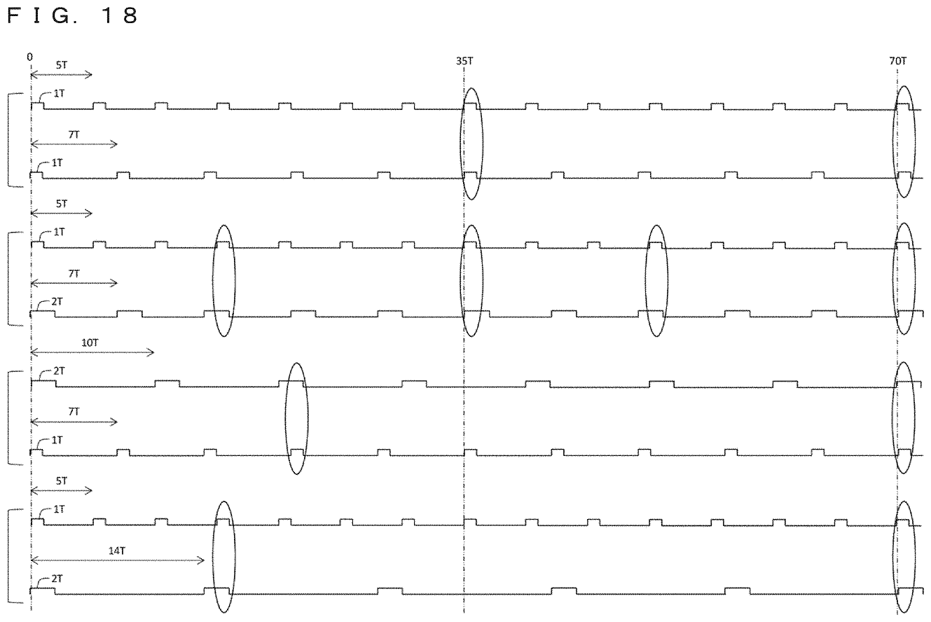

FIG. 15 and FIG. 16 are diagrams for description of a method of determining (de-aliasing) the distance using the first/second distance measurement results. Here, 1T=10 nsec.

FIG. 15 illustrates the first and second distance measurement results. The first distance data D_{1T} (indicated by a solid line) in the first distance measurement period (pulse width=1T) is a straight line having a repetition, and a repetition distance R_{1T} is 3cT/2=4.5 m. The second distance data D_{2T} (indicated by a broken line) in the second distance measurement period (pulse width=2T) is a straight line without repetition.

In Example 2, the distance measurement ranges in the first distance data and the second distance data are different from each other. That is, a reflected light delay time dT_{R1} and a distance measurement range D_{R1} in the first distance measurement period are

dT_{R1}=1T·(2×3−1)=5T,D_{R1}=7.5 m.

A reflected light delay time dT_{R2} and a distance measurement range D_{R2} in the second distance measurement period are

dT_{R2}=2T·(1×3−1)=4T,D_{R2}=6 m.

In de-aliasing, using the second distance data D_{2T}, the number n of repetitions in the first distance data D_{1T} is obtained in the following procedure. First, a ratio n′ of a difference amount between the first and second distance data to the repetition distance R_{1T} (=3cT/2) of the first distance measurement period is obtained.

n′=(D_{2T}−D_{1T})/R_{1T}

n′ is indicated by a dotted line. Since measurement errors are included in the first distance data D_{1T} and the second distance data D_{2T}, n′ is not an original integer value and is involved with a fraction after a decimal point. Therefore, n′ is converted into an integer.

n=ROUND(n′)

Thus, a real value (integer value) n of the number of repetitions is obtained.

In this example, the distance measurement ranges D_{R1} and D_{R2} of D_{1T} and D_{2T} do not match each other. Thus, in a distance range 6 to 7.5 m, n′ varies from 1 to 0.66. However, by setting n=1 using a round function, it is possible to correctly perform de-aliasing. In addition, conversion from n′ into an integer n is not limited to the round function (rounding off), and a threshold value may be freely set according to a variation of a value of n′. In this example, it is possible to set n=0 when n′ 0.4, and n=1 when 0.4<n′.

FIG. 16 illustrates a distance output after de-aliasing. Using the true value n of the number of repetitions described above, the accurate distance D is determined by the following equation.

D=D_{1T}+n·R_{1T}=D_{1T}+n·3cT/2

In this computation, since the first distance data D_{1T} has high distance measurement accuracy and the repetition distance R_{1T} to be added is a constant (3cT/2) determined from the unit time T and the speed of light c, the accurate distance D can be determined. In this way, measurement can be performed by achieving both high distance measurement accuracy and a wide distance measurement range.

In the case of Example 2, an exposure time is shortened in both the first distance measurement period and the second distance measurement period, and thus Example 2 is advantageous when compared to Example 1 in an environment in which there is a concern about a reduction in distance measurement accuracy due to external light such as sunlight. In addition, in Example 2, since the first non-exposure period 86 and the second non-exposure period 89 are provided, it is possible to reduce distance measurement errors due to interference between a plurality of apparatuses while ensuring high distance measurement accuracy as in Example 1.

<Relationship Between Pulse Width and Number of Times of Repetitive Exposure>

Here, a description will be given of an optimum relationship between the pulse width of the first distance measurement period (high frequency) and the number of times of repetitive exposure, and the pulse width of the second distance measurement period (low frequency).

In Example 1, the distance measurement ranges of the first and second distance measurement periods are made equal to each other. However, for example, a case in which the pulse width of the second distance measurement period is further widened and the distance measurement range of the second distance measurement period is made wider than the distance measurement range of the first distance measurement period is considered.

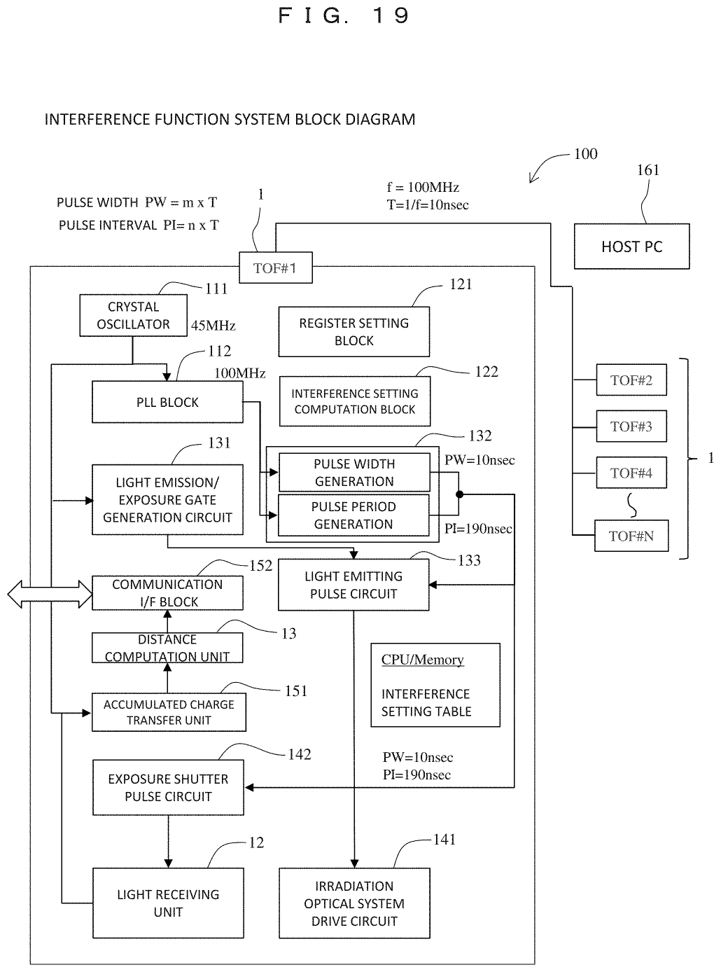

FIG. 17 is a diagram illustrating a case in which a measurement error is likely to occur as a modification of FIGS. 5A and 5B. A distance measurement result of a case in which the pulse width of the first distance measurement period of FIG. 5A is 1T and the pulse width of the second distance measurement period of FIG. 5B is widened to 5T is shown. The first distance data D_{1T} is indicated by a solid line, the second distance data D_{5T} is indicated by a broken line, and a ration n′ obtained by dividing a difference therebetween by the repetition distance R_{1T} is indicated by a dotted line.

In this case, since the distance measurement ranges D_{R1} and D_{R5} of the first and second distance data D_{1T} and D_{5T} are not equal to each other, n′ changes from 2 to 2.3 in a range of 12 to 13.5 m. However, de-aliasing can be performed by setting n=2 using a round function. However, when the pulse width of the second distance measurement period is widened to 5T, shot noise increases, the error of the second distance data D_{5T} increases, and the variation in the value of n increases. Thus, an error is more likely to occur during de-aliasing when compared to a case in which the pulse width is 4T. Therefore, it is desirable that the distance measurement range of the first distance measurement period and the distance measurement range of the second distance measurement period are made equal to each other.

When the pulse width of the first distance measurement period is set to T_{H}, the pulse width of the second distance measurement period is set to T_{L}, and the distance measurement ranges corresponding thereto are set to D_{RH} and D_{RL}, a condition under which the distance measurement ranges of the first and second distance measurement periods are equal to each other is as follows.

D_{RH}=(cT_{H}/2)·(3−1)

D_{RL}=(cT_{L}/2)·(3n−1)

Here, c is the speed of light, and n is the number of times of repetitive exposure. A condition for D_{RH}=D_{RL} is as follows.

T_{L}/T_{H}=(3n−1)/2

In Example 1 (FIGS. 5A and 5B), when the pulse width ratio is set to T_{L}/T_{H}=4, and the number of times of repetitive exposure on the pulse width T_{H} side is set to n=3, the condition for D_{RH}=D_{RL} is satisfied. However, when n is an even number, T_{L}/T_{H} does not become an integer. For example, when n=2, T_{L}/T_{H}=2.5 does not become an integer. In this case, the pulse width ratio T_{L}/T_{H} may be set to 2.5 times without change.

However, T_{L} can be only set to an integer multiple of T_{H} in some cases. In this case, it is sufficient to use an integer value rounded off after the decimal point. That is, it is possible to use T_{L} obtained with respect to T_{H} using the following equation.

T_{L}/T_{H}=ROUNDDOWN[(3n−1)/2]

The ROUNDDOW function performs processing to omit figures below the decimal point here.

Example 2 corresponds to this case, and the condition for D_{RH}=D_{RL} is approximately satisfied by setting the pulse width ratio to T_{L}/T_{H}=2 and the number of times of repetitive exposure on the pulse width T_{H} side to n=2.

According to the condition described above, since the distance measurement range of the first distance measurement period and the distance measurement range of the second distance measurement period are equal or close to each other, the distance measurement accuracy and the performance in the distance measurement range are balanced, and thus it is possible to perform most efficient measurement.

Meanwhile, for example, in an application that analyzes flow lines of people in a store, it is conceivable to use a plurality of distance measurement image pickup apparatuses, the number of which exceeds ten. Further, as an example of measures against occlusion, it is necessary to reduce the installation interval of the distance measurement image pickup apparatuses from the conventional interval of 3 m to 50 cm or less. However, as the installation interval is narrowed, the interference intensity of pulsed light emitted between the apparatuses increases. Even with the measures against interference light described above, there is a problem that a distance measurement error exceeds 5 cm. In addition, for example, when detecting stretching of a hand for a shelf in a store, from a viewpoint of improving measurement accuracy at a short distance, it is considered necessary to install a long distance-range distance measurement image pickup apparatus (in other words, a distance measurement image pickup apparatus that emits pulsed light having a large pulse width) and a short distance-range distance measurement image pickup apparatus (in other words, a distance measurement image pickup apparatus that emits pulsed light having a small pulse width) in a coexisting manner. Therefore, next, a description will be given of a distance measurement system capable of performing accurate measurement even when a distance between the apparatuses is narrowed and distance measurement image pickup apparatuses of different ranges coexist as described above.

First, with reference to FIG. 18, a description will be given of occurrence of interference at pulse intervals when pulse widths between the apparatuses are the same and when the pulse widths between the apparatuses are not the same. Note that a pulse interval corresponds to a value of pulse period×reference clock.

FIG. 18 illustrates an example in which the reference clocks are common, the pulse widths are the same at 1T, and the pulse intervals are different at 5T and 7T. In this case, interference occurs repeatedly at intervals of 35T, 70T, 105T, . . . , In FIG. 18, a portion where interference occurs is surrounded by an ellipse. Next, an example is considered in which the reference clocks are common, the pulse widths are different at 1T and 2T, and the pulse intervals are different at 5T and 7T. In this case, interference previously occurs once up to 35T, and interference occurs again at 35T. As described above, interference is more likely to occur when the pulse widths are different than when the pulse widths are the same. This example will be specifically considered using a mathematical formula. When pulsed light rays having a pulse width (m1×T) and a pulse width (m2×T) are emitted at different pulse intervals, (M1−1)+(m2−1) interferences occur until the light emitting timings coincide with each other. Here, m1 and m2 are arbitrary natural numbers.

Further, FIG. 18 illustrates an example in which the pulse intervals are multiplied by integers, and as an example thereof, an example in which the pulse widths are different at 1T and 2T and the pulse intervals are different at 10T(5T×2) and 7T is illustrated. Further, in this example, even when the pulse widths are different, interference occurs once before 35T, and interference occurs again at 70T. Further, as an example, an example in which the pulse widths are different at 1T and 2T and the pulse intervals are different at 5T and 14T(7T×2) is illustrated. In this example, interference occurs once before 35T and interference occurs again at 70T. Therefore, when pulse widths are different, the frequency of interference is reduced by multiplying the pulse interval by integers.

A ratio will be considered for specific description. As illustrated in FIG. 18, when the interference ratio is determined by the amount of interference (number of times of interference) in a predetermined period, the interference ratio is 1/35 in an example where the pulse widths are the same at 1T and the pulse intervals are different at 5T and 7T. When the pulse widths are different at 1T and 2T, the interference ratio becomes 2/35. Here, when the pulse widths are different by setting the pulse intervals to 10T(5T×2) and 7T, the interference ratio becomes 2/70 (that is, 1/35), and the interference ratio is reduced. Further, by setting the pulse intervals to 5T and 14T(7T×2), the interference ratio becomes 2/70 (that is, 1/35), and the interference ratio is similarly reduced. Therefore, when the pulse widths are different, the interference frequency can be reduced by multiplying the pulse intervals by integers.

Next, an example of a system for realizing the above-mentioned interference suppression effect will be described. FIG. 19 illustrates an example of a functional block diagram (interference functional system block diagram) of a distance measurement system.

As illustrated in FIG. 19, each distance measurement image pickup apparatus (TOF #1 to n) in the distance measurement system 100 includes a crystal oscillator 111 and a PLL block 112. The crystal oscillator 111 and the PLL block 112 generate a reference clock. Note that each apparatus (TOF #1 to n) performs processing based on a common reference clock. Further, as an example, the reference clock may be set to 100 MHz (10 nsec). Here, as an example, the crystal oscillator 111 oscillates at a frequency of 45 MHz.

Further, each apparatus (TOF #1to n) includes a register setting block 121 and an interference setting computation block 122. The register setting block 121 has a function of setting a register. The interference setting computation block 122 has a function of setting a pulse period, and detailed processing will be described in detail later.

Further, each distance measurement image pickup apparatus (TOF #1 to n) includes a light emission/exposure gate generation circuit 131, a pulse generation unit 132, and a light emitting pulse circuit 133. The light emission/exposure gate generation circuit 131 is a circuit for generating a gate used for light emission and an exposure gate based on the reference clock. The pulse generation unit 132 is used to generate a pulse width and a pulse interval based on the reference clock. The light emitting pulse circuit 133 is a circuit used to generate pulsed light using the generated gate by an appropriately generated pulse width (in this example, PW=1×T=10 nsec) and a pulse interval based on the pulse period (in this example, the pulse period is 19 and PT=19×nsec). Note that each distance measurement image pickup apparatus (TOF #1 to n) may be configured so that the pulse width may be switched, and the pulse width used for the measurement may be appropriately selected by the user.

Further, each distance measurement image pickup apparatus (TOF #1 to n) includes an irradiation optical system drive circuit 141 and an exposure shutter pulse circuit 142. The irradiation optical system drive circuit 141 is a circuit used to drive an irradiation optical system to irradiate pulsed light based on input from the light emitting pulse circuit 133 from the light source. The exposure shutter pulse circuit 142 is a circuit used to control the timing of exposure using the exposure gate when performing measurement based on an appropriately set pulse width and pulse period. The light receiving unit 12 performs exposure based on input from the exposure shutter pulse circuit 142.

Further, each distance measurement image pickup apparatus (TOF #1 to n) includes an accumulated charge transfer unit 151 and the distance computation unit 13. The accumulated charge transfer unit 151 is used to transfer charges accumulated in the exposure gate during the measurement period and use the charges for distance calculation. The distance computation unit 13 is used to calculate the distance based on the accumulated charges by the above-mentioned calculation method.

Further, each distance measurement image pickup apparatus (TOF #1 to n) includes a communication I/F block 152. The communication I/F block 152 is included in an interface for communication, and is used, for example, to output data (calculated distance data, etc.) to the outside. Note that data output from each distance measurement image pickup apparatus (TOF #1 to n) may be received and acquired by a host PC 161. Then, the host PC 161 may aggregate the data from each distance measurement image pickup apparatus (TOF #1 to n) and output the resulting data. Further, data such as the pulse period and the pulse width of the pulsed light emitted by each distance measurement image pickup apparatus (TOF #1 to n) may be output to the host PC 161.

Furthermore, for example, the host PC 161 may be used to control each distance measurement image pickup apparatus (TOF #1 to n) so that measurement using the common reference clock is performed, or monitor whether measurement is performed using the common reference clock. Further, a command for setting a register, a pulse width, a pulse period, etc. may be output from the host PC 161 to each distance measurement image pickup apparatus (TOF #1 to n).

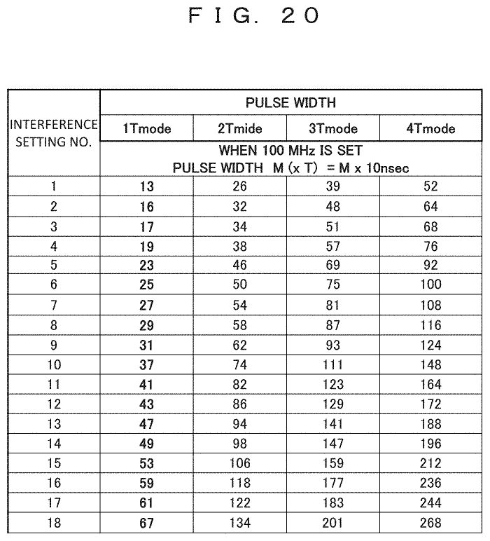

Next, details of processing of the interference setting computation block 122 will be described. Note that the subject of the processing of the interference setting computation block 122 is a processor (CPU in this example). By the processing of the interference setting computation block 122, the pulse period is set, and an interference setting table (data in the format illustrated in FIG. 20 as an example) is generated.

A sampling clock is set in the interference setting computation block 122. The sampling clock may be the same as the reference clock generated by the crystal oscillator 111 and the PLL block 112.

In addition, in the interference setting computation block 122, a minimum pulse period, which is a least pulse period, is set. The minimum pulse period may be set to 13 as an example.

Further, in the processing of the interference setting computation block 122, information about the number of interference suppression settings is used. The number of interference suppression settings includes information related to information about a type of pulse width and information about the number of integers used to set the pulse period. The number of interference suppression settings may be appropriately set in the format of data in which the type of pulse width used for measurement is set to m (m=1, 2, 3 . . . ) and the number of integers used for setting the pulse period is set to n (n=1, 2, 3, . . . ), and stored in the distance measurement image pickup apparatuses (TOF #1 to n). In this case, mT×nT pulse periods (that is, m×n pulse periods) are set.

The integers used to set the pulse periods are arranged, for example, in an integer table, and the integer table is stored in an appropriate storage device (for example, a memory). The integers used to set the pulse periods may be natural numbers of 2 or more.

Further, in the processing of the interference setting computation block 122, different integers used to set the pulse periods are appropriately acquired from the integers stored in the integer table. Here, integers larger than or equal to the minimum pulse period are acquired, and as an example, integers larger than or equal to 13 are acquired. From the integers arranged in the integer table, n integers larger than or equal to the minimum pulse period may be acquired from a small value.

Further, in the processing of the interference setting computation block 122, after each different integer to be used is acquired, a value obtained by multiplying each different integer by an integer, which is a natural number, is obtained, and m×n pulse periods are obtained. Then, an interference setting table for storing m×n pulse periods in proportion to the size of the pulse width is generated.

Here, the interference setting table includes a pulse period as data related to an interval of pulsed light, and as an example, as illustrated in FIG. 20, the interference setting table may have a data format in which different interference setting Nos. are assigned to different integers, respectively. Here, from a viewpoint of generating appropriate data for suppressing interference, as illustrated in FIG. 20, it is preferable that the interference setting table is generated so that pulse periods having the same value are reduced (or not included) in a relationship between the same and different pulse widths. Further, it is preferable that an integer capable of generating such an interference setting table is acquired from the integer table when the interference setting table is generated. Note that the generated interference setting table is output to an appropriate storage device (for example, a memory) and stored.

When measurement is performed using the distance measurement system 100, a pulse period of pulsed light emitted by each distance measurement image pickup apparatus (TOF #1 to n) is appropriately selected from the interference setting table stored in each apparatus. Then, measurement is performed at an interval of pulsed light rays based on the reference clock common to each distance measurement image pickup apparatus (TOF #1 to n).

Here, for example, when measurement is performed by setting the pulse width of each distance measurement image pickup apparatus (TOF #1 to n) to 1T in common, a pulse period corresponding to the pulse width 1T of the interference setting table is appropriately selected in each distance measurement image pickup apparatus (TOF #1 to n), and measurement is performed based on the selected pulse period.

The distance measurement system 100 may perform measurement using different pulse widths between the distance measurement image pickup apparatuses (TOF #1 to n). For example, when measurement is performed by setting a pulse width of a certain apparatus to 2T, a pulse period corresponding to a pulse width 2T of an interference setting table of the apparatus is selected for the apparatus. Irradiation of pulsed light having a large pulse width has a greater effect of interference on other apparatuses than irradiation of pulsed light having a small pulse width. However, by using a pulse period that is an integer multiple (double or more) for a distance measurement image pickup apparatus having a large pulse width in this way, an interference residual between apparatuses (that is, an interference ratio between apparatuses) may be made uniform to easily obtain an appropriate interference suppression effect.

Note that the pulse period is selected so as to be different between the respective distance measurement image pickup apparatuses (TOF #1 to n) in measurement of the distance measurement system 100. Therefore, in measurement of the distance measurement system 100, pulse widths between the respective distance measurement image pickup apparatuses (TOF #1 to n) are all different.

The distance measurement system 100 can perform suitable measurement even when the apparatus interval is shortened by using the interference suppression measures described above. Further, the number of distance measurement image pickup apparatuses (TOF #1 to n) included in the distance measurement system 100 may be set to 10 or more (n≥10) as an example, and ten or distance measurement image pickup apparatuses may be used to perform measurement.

The invention is not limited to the above contents, and includes various modifications. For example, the above-mentioned examples, etc. have been described in detail for a better understanding of the invention, and are not necessarily limited to those including all the configurations of the description.

In the above description, the crystal oscillator 111 and the PLL block 112 are included in an emission source of the reference clock. However, for example, the emission source may include only the crystal oscillator 111. Alternatively, the emission source may include a reference clock generator built in the PLL.

Various types of data (tables or programs) can be stored in an appropriate storage device (for example, a memory included in the distance measurement image pickup apparatus). The processing of the distance measurement system 100 is performed by a processor executing an appropriate program for performing predetermined processing. For example, the processing of the distance measurement image pickup apparatus (TOF #1 to n) is performed by, as an example, a processor (the controller 14 which is a CPU included in the distance measurement image pickup apparatus) included in the distance measurement image pickup apparatus (TOF #1 to n). A CPU or GPU can be considered as an example of the processor. However, other semiconductor devices may be used as long as the semiconductor devices are main constituents that execute predetermined processing.

What is claimed is:

1. A distance measurement system for measuring a distance to a target by a time of flight of light using a plurality of distance measurement image pickup apparatuses,
wherein each of the distance measurement image pickup apparatuses includes
a light emitting unit configured to irradiate the target with pulsed light emitted by a light source,
a light receiving unit configured to expose pulsed light reflected by the target using an image sensor and convert the pulsed light into an electric signal,
a distance computation unit configured to compute a distance to the target from an output signal of the light receiving unit, and
a controller configured to control a light emission timing for emitting pulsed light from the light emitting unit and an exposure timing for exposing pulsed light by the light receiving unit,
the plurality of distance measurement image pickup apparatuses is allowed to emit pulsed light rays at a plurality of different pulse widths,
intervals of pulsed light rays from the plurality of distance measurement image pickup apparatuses are set to be proportional to pulse widths in the respective distance measurement image pickup apparatuses, and
the respective distance measurement image pickup apparatuses emit pulsed light rays at intervals of the pulsed light rays corresponding to pulse widths and the intervals of the pulsed light rays different from each other.

2. The distance measurement system according to claim 1,
wherein each of the distance measurement image pickup apparatuses generates an interference setting table for storing data related to an interval of pulsed light based on a different integer for each pulse width, and
an interval of pulsed light of each of the distance measurement image pickup apparatuses is determined with reference to the interference setting table.

3. The distance measurement system according to claim 2, wherein data related to an interval of pulsed light in the interference setting table is set based on the integer of 13 or more.

4. The distance measurement system according to claim 2, wherein an interference setting table is generated, data values related to intervals of pulsed light rays being all different in a relationship between the same and different pulse widths in the interference setting table.
